(19) United States
(12) Patent Application Publication
(10) Pub. No.: US 2024/0010565 A1
(43) Pub. Date: Jan. 11, 2024

(54) SHAPED BODY, COMPOSITE BODY, METHOD FOR PRODUCING A SHAPED BODY AND METHOD FOR PRODUCING A COMPOSITE BODY

(71) Applicant: HUG Engineering AG, Elsau (CH)

(72) Inventors: Adrian MARBERGER, Elsau (CH); Andreas Klimera, Elsau (CH); Georg Vieweger, Salem-Beuren (DE)

(21) Appl. No.: 17/913,276

(22) PCT Filed: Mar. 26, 2021
(86) PCT No.: PCT/EP2021/058013

§ 371 Date: Feb. 8, 2023

(30) Foreign Application Priority Data
Mar. 26, 2020 (DE) 102020203924.0

(51) Int. Cl. C04B 35/10; C04B 35/185; C04B 35/64; C04B 38/00; C04B 38/06; C04B 41/50; C04B 41/45; C04B 41/00; C04B 41/87

(52) U.S. Cl. CPC C04B 35/10; C04B 35/185; C04B 35/64; C04B 38/0054; C04B 38/067; C04B 38/068; C04B 41/5041; C04B 41/5072; C04B 41/4535; C04B 41/0072; C04B 41/87; C04B 2235/3217; C04B 2235/3463; C04B 2235/3232; C04B 2235/3205; C04B 2235/77; B01D 46/2429

(57) ABSTRACT

In order to provide a shaped body which has good high-temperature resistance, to which a coating material adheres permanently, and which is easy to produce, a shaped body is proposed which has a channel structure formed by shaping a material of the shaped body and a pore structure in the material of the shaped body, wherein the material of the shaped body comprises a particulate base material or is formed therefrom at least in part, wherein the base material comprises a cordierite material and/or a mullite material, wherein particles of the base material are connected to one another directly and/or indirectly, and wherein approximately 5 vol. % of a coating material or more, based on a total volume of the pore structure, can be or is absorbed into pores of the pore structure.

The present invention relates to a shaped body.

The present invention also relates to a composite body.

The present invention also relates to a method for producing a shaped body and to a method for producing a composite body.

Shaped bodies are known from DE 10 2013 204 276 A1.

The object of the present invention is to provide a shaped body which has good high-temperature resistance, to which a coating material adheres permanently, and which is easy to produce.

According to the invention, this object is achieved by a shaped body according to claim 1.

The shaped body is designed in particular as a carrier body for a coating material.

The shaped body preferably comprises the following:
a channel structure which is formed by shaping a material of the shaped body; and
a pore structure in the material of the shaped body.

It may be advantageous if the material of the shaped body comprises a particulate base material or is formed therefrom at least in part. The base material comprises in particular a cordierite material and/or a mullite material or is formed therefrom.

For example, the cordierite material is a cordierite chamotte. The mullite material is, for example, a mullite chamotte.

It may be advantageous if particles of the base material are connected to one another directly and/or indirectly. Approximately 5 vol. % of a coating material or more, based on a total volume of the pore structure, can be and/or is absorbed into pores of the pore structure.

Preferably, approximately 10 vol. % of the coating material or more, based on the total volume of the pore structure, can be or is absorbed into pores of the pore structure.

Adhesion properties of the coating material can be improved by the absorption of the coating material into pores of the pore structure.

By using particulate base material, a random orientation of the particles can be formed in the material of the shaped body. In this way, a preferred orientation can be avoided and/or the material of the shaped body can have the same thermal conductivity properties in all spatial directions.

In particular, the coating material forms an active material which acts, for example, as a catalyst material.

For example, the shaped body is suitable as a carrier body for 3-way catalytic converter applications and/or diesel oxidation catalytic converter applications and/or SCR (selective catalytic reduction) applications.

The shaped body is preferably a ceramic body.

The particles of the base material are preferably connected to one another while retaining their particle properties.

For this purpose, it may be favorable if the particulate base material is pre-fired and/or ground up.

The cordierite material is preferably a pre-calcined cordierite material which has been ground up in particular after the calcination. The cordierite material can be a cordierite chamotte, for example.

In embodiments in which the shaped body comprises a mullite material or is formed therefrom, a pre-calcined mullite material is preferably used which was ground up in particular after the calcination.

The mullite material can be, for example, mullite chamotte, sintered mullite and/or fused mullite.

“Chamotte” is understood to mean a fired or pre-fired and then ground-up material.

Reaction and/or melting properties of the cordierite material and/or the mullite material can be changed by the calcination. In this way, the pre-calcined cordierite material and/or the pre-calcined mullite material of the base material can substantially retain their particle properties in a firing process for forming the shaped body.

For example, the calcination of the cordierite material and/or the mullite material occurs at approximately 1000° C. or more and/or at approximately 1700° C. or less.

In this description and the accompanying claims, “particle property” is understood in particular to mean that clear boundaries of the particles can be seen in a scanning electron microscope (SEM) image of the shaped body. The particles are preferably embedded and/or crosslinked with one another, for example bonded. The particles are preferably not completely melted and are fused with other particles to form a larger body.

By connecting the particles via the binding material, the random orientation of the particles of the base material can be retained and/or fixed.

In particular, approximately 30% of a volume of the particles of the base material or less are melted.

A core part of each particle that is remote from the surface preferably remains physically and/or chemically unchanged.

A crystal structure of the particles of the base material preferably remains substantially unchanged.

The channel structure is preferably a macroscopic channel structure which can be seen in particular with the naked eye.

The pore structure is preferably a microscopic pore structure which cannot be seen with the naked eye and/or can only be seen in an electron microscope image.

The total volume of the pore structure is preferably an outer volume of the pore structure. In particular, the total volume of the pore structure is volume formed by a porosity of cavities formed and/or minus (macroscopic) cavities formed in the channel structure.

It may be advantageous if the shaped body and the coating material engage in one another when the shaped body is in a coated state.

The shaped body and the coating material preferably form a composite body in a coated state of the shaped body with the coating material.

The surfaces of the pore structure and of the coating material are in particular interlinked in the coated state of the shaped body.

In particular, the pore structure is openly porous and/or has no closed surface and/or closed skin on surfaces facing cavities of the channel structure.

It may be favorable if the pore structure has a rough surface.

Due to the pore structure in the material of the shaped body, the shaped body preferably has a sponge effect, so that the coating material can penetrate into the pore structure in the material of the shaped body during production of the composite body.

The coating material is preferably arranged on the insides of walls that delimit cavities of the channel structure and/or completely covers the walls of the channel structure.

It may be advantageous if the material of the shaped body comprises a binding material by means of which particles of the base material are connected to one another, in particular integrally.

The binding material forms, for example, a matrix material in which particles of the base material are absorbed and/or distributed.

In particular, the binding material or one or more precursors of the binding material comprises one or more of the following materials or is formed therefrom:
one or more transition metal oxides, in particular titanium oxide;
one or more aluminum oxides;
one or more alkaline earth metal oxides, in particular magnesium oxide; and
one or more silicates.

In addition, aluminum hydroxide can form a material of the binding material or a precursor thereof.

The binding material preferably acts as an adhesive that holds the particles of the base material together.

It may be advantageous if a proportion of binding material in the shaped body is approximately 10 wt. % or more and/or approximately 40 wt. % or less, based on a total mass of the shaped body.

The proportion of binding material in the shaped body is in particular approximately 15 wt. % or more and/or approximately 30 wt. % or less, based on the total mass of the shaped body.

It may be advantageous if the shaped body is produced in a rapid firing process. A chemical reaction of one or more precursors of the binding material can thus take place, while the particles of the base material remain chemically unchanged for the most part, for example 50 vol. % or more, based on a total volume of the relevant particle.

It may be advantageous if a porosity of the pore structure is approximately 35% or more, in particular approximately 43% or more.

In particular, the porosity of the pore structure is approximately 54% or less, for example approximately 46% or less.

The porosity is preferably defined as a ratio of a cavity volume and the total volume of the pore structure of the shaped body. In particular, volumes formed by cavities in the channel structure of the shaped body are not taken into account in the porosity.

The porosity reduces in particular a specific thermal capacity of the material of the shaped body in comparison with materials of the same composition with a lower porosity. When the shaped body is used in exhaust gas aftertreatment, a response time to a temperature change with regard to the exhaust gas flowing through the shaped body can be optimized.

It may be favorable if an average pore diameter of the pores of the pore structure is approximately 7 μm or more, in particular approximately 10 μm or more.

An average pore diameter of the pores of the pore structure is preferably approximately 20 μm or less, in particular approximately 16 μm or less.

For example, the average pore diameter of the pores of the pore structure is approximately 12 μm or more and/or approximately 15 μm or less.

Due to the comparatively high porosity in particular of pores which are open toward the coated surface of the shaped body, an optimized interaction between the surface of the shaped body and the coating material can be formed. Furthermore, a higher loading of the shaped body with the coating material can be formed. In particular, the loading of catalytically active coating material can be increased in this way without an open cross section of the cavities of the shaped body being reduced. In this way, optimized activity as an SCR material can be achieved.

The shaped body preferably has a reduced bulk density (without cavities formed by the channel structure) due to the comparatively high porosity. In an application in exhaust gas aftertreatment, this can lead to an optimized start-up behavior, in particular since less mass has to be heated. In this way, a state of maximum turnover can be reached more quickly.

Within the meaning of the present description and the appended claims, “bulk density” is preferably understood to mean a density of the corresponding body based on its volume, including the pore spaces it contains. In particular, cavities formed by the channel structure are not included in the bulk density unless explicitly stated.

The shaped body is preferably a honeycomb body, in particular a substrate for a catalytic coating.

In particular, the shaped body is suitable for use as a catalyst support.

A preform of the shaped body can be shaped, for example, in a pressing process and/or an extrusion process.

A shaped body designed as a honeycomb body preferably has honeycombs arranged in a matrix. In particular, it can be provided that the honeycomb body has a square cross section and comprises honeycombs (cells) which are arranged in a matrix and are cylindrical, the honeycombs (cells) preferably also having a square cross section.

It may be favorable if the shaped body comprises 100 cells per square inch or more and/or 300 cells per square inch or fewer. For example, the shaped body comprises 150 cells per square inch or 100 cells per square inch.

It may be advantageous if the shaped body has a mass concentration of approximately 450 g/l or less, in particular approximately 360 g/l or less.

The mass concentration is preferably a bulk density of the shaped body plus cavities formed by the channel structure. In particular, the mass concentration is a volume weight of the shaped body.

Walls separating individual cavities of the channel structure of the shaped body preferably have a wall thickness of approximately 500 μm or less and/or approximately 200 μm or more.

An average grain size (particle size) of the particles of the base material is preferably approximately ⅖ or less, more preferably ⅓ or less, of a wall thickness of the walls of the shaped body.

The wall thickness is preferably an average wall thickness.

In particular, the average grain size (particle size) of the particles of the base material is approximately 1/20 or more of the average wall thickness of the shaped body.

It may be advantageous if an average grain size of the particles of the base material is approximately 100 μm or less.

A grain size d₅₀ of the particles of the base material made of cordierite material and/or mullite material is in particular approximately 15 μm or more, in particular approximately 40 μm or more, and/or approximately 60 μm or less.

A grain size distribution (particle size distribution) of the particles of the cordierite material is preferably as follows:
d₁₀ approximately 1 μm or more and/or approximately 3 μm or less, for example 2 μm; and/or
d₅₀ approximately 10 μm or more and/or approximately 28 μm or less, for example approximately 18 μm; and/or
d₉₀ approximately 30 μm or more and/or approximately 40 μm or less, for example 35 μm.

A d₁₀ value is understood to mean the particle size below which 10% of the particles of the relevant substance fall, while 90% of the particles of the relevant substance are larger than the d₁₀ value.

A d₅₀ value is understood to mean the particle size below which 50% of the particles of the relevant substance fall, while 50% of the particles of the relevant substance are larger than the d₅₀ value.

A d₉₀ value is understood to mean the particle size below which 90% of the particles of the relevant substance fall, while 10% of the particles of the relevant substance are larger than the d₉₀ value.

The particle size distribution can be obtained, for example, by sieving the particles.

The invention also relates to a composite body.

In this regard, the invention is based on the object of providing a composite body which is easy to produce and has high temperature stability and high mechanical stability.

According to the invention, this object is achieved by a composite body according to independent claim 5.

The composite body preferably comprises a shaped body according to the invention and a coating material.

The composite body according to the invention preferably has one or more features and/or one or more advantages of the shaped body according to the invention.

The composite body is particularly suitable for use in the selective catalytic reduction of nitrous gases using ammonia (SCR applications) and/or in the oxidation of hydrocarbons using diesel oxidation catalysts.

For example, the composite body can be used in exhaust gas aftertreatment.

It may be advantageous if the coating material extends into pores of the pore structure of the shaped body when the shaped body is in a coated state.

Additionally or alternatively, it may be advantageous if the coating material is chemically and/or physically connected to the material of the shaped body.

One or more components and/or one or more substances and/or one or more materials are preferably contained in the same chemical composition and/or in chemically identical form both in the material of the shaped body and in the coating material.

For example, one or more crystal structures in the material of the shaped body and the coating material match.

Additionally or alternatively, one or more compounds are contained in chemically and/or physically identical form both in the material of the shaped body and in the coating material.

For SCR applications in particular, it may be advantageous if the coating material comprises one or more of the following materials or is formed therefrom: titanium dioxide, vanadium oxide, in particular vanadium (V) oxide, tungsten oxide, in particular tungsten (VI) oxide.

In an application in a composite body, a vanadium content is preferably lower than a vanadium content in a solid extrudate, based on a total mass of the composite body or the solid extrudate.

Due to the lower proportion of vanadium oxide, the formation of corrosive sulfuric acid can be reduced in one application of the composite body.

In particular for SCR applications, the coating material is preferably a titanium dioxide-based material which comprises, for example, approximately 80 wt. % or more, in particular approximately 85 wt. % or more, titanium dioxide, based on a total mass of the coating material.

It may be advantageous if the coating material comprises approximately 95 wt. % or less, in particular approximately 92 wt. % or less, titanium dioxide, based on the total mass of the coating material.

According to a preferred embodiment, the coating material comprises approximately 0.5 wt. % to approximately 3 wt. % vanadium (V) oxide, for example approximately 2 wt. % vanadium (V) oxide, based on a total mass of the coating material after calcination.

Preferably, the coating material comprises approximately 5 wt. % to approximately 10 wt. % tungsten (VI) oxide, based on the total mass of the coating material after calcination.

Furthermore, according to the preferred embodiment, the coating material comprises approximately 88 wt. % to approximately 93 wt.% titanium dioxide, based on a total mass of the coating material after calcination.

For example, the coating material is in powder form.

For coating the shaped body with the coating material, it may be favorable if a coating material mixture comprises a liquid in an amount which substantially corresponds to a pore volume of the pore structure of the shaped body.

Measurements have shown that NOₓ activity through the composite body at approximately 300° C. to approximately 500° C. is preferably approximately 30% higher than NOₓ activity in a comparable solid extrudate with the same composition and identical measurement conditions.

The invention also relates to a method for producing a shaped body, in particular a shaped body according to the invention.

In this regard, the object of the invention is to provide a method for producing a shaped body, by means of which a shaped body with good high-temperature resistance can be produced in a simple manner.

According to the invention, this object is achieved by a method according to independent method claim 9.

According to the method, a mixture is preferably provided which comprises a particulate base material or is formed therefrom. The particulate base material is preferably pre-fired and/or ground up. In particular, the particulate base material comprises a cordierite material and/or a mullite material or is formed therefrom.

According to the method, a preform is preferably produced by shaping the mixture, with a channel structure being formed in particular.

It may be advantageous if the preform is fired, so that particles of the base material are connected to one another directly and/or indirectly, as a result of which a shaped body is formed. In particular, the shaped body has a pore structure. Approximately 5 vol. % of a coating material or more, based on a total volume of the pore structure, can be absorbed into pores of the pore structure.

The method according to the invention preferably has one or more features and/or one or more advantages of the shaped body according to the invention and/or the composite body according to the invention:

The shaped body is preferably fired in a rapid firing process with a temperature gradient of >2300° C. (more than 2300° C.), in particular >2200 K/m (more than 2200 K/m) and/or >2200 K/h (more than 2200 K/h), for example in the range between approximately 120° C. and approximately 2000° C.

Preferably, the shaped body is fired at a temperature of at most approximately 1400° C. In this way, it is possible to connect the particles of the base material to one another while maintaining the particle property. In particular, it is possible to prevent an undesired conversion of the base material, for example complete melting of the particles of the base material, from occurring at a temperature above approximately 1400° C.

The temperature is preferably chosen so that solid-state reactions lead to the formation of the dimensionally stable shaped body.

In one embodiment of the invention, the shaped body is fired at a temperature of approximately 1300° C.

It may be favorable if the preform is fired in a firing cycle lasting at least approximately 300 minutes and/or at most approximately 480 minutes, for example approximately 360 minutes.

The duration of the firing cycle is understood to mean the time between the start of the firing process of the preform and the end of the firing process, in particular when the shaped body formed during the firing process is removed from a furnace. In particular, this is understood to mean the length of time between the start of the firing process and the cooling of the fired shaped body.

According to a preferred embodiment, the base material consists substantially of the cordierite material.

According to another preferred embodiment, the base material comprises approximately 90 wt. % cordierite material or more, in particular approximately 95 wt. % or more, based on a total mass of the base material.

In particular, the base material comprises approximately 10 wt. % mullite material or less, in particular approximately 5 wt. % or less, based on the total mass of the base material.

It may be favorable if the mixture comprises one or more precursors of a binding material and in that the particles of the base material are taken up by the binding material by chemical and/or physical reaction of the one or more precursors to the binding material and/or are connected to one another by the binding material.

It may be favorable if an average grain size of the particles of the base material is greater by a factor of 2 or more than a grain size of one or more precursors which, by firing, form a binding material of the material of the shaped body.

In particular, one or more precursors of the binding material react chemically and/or physically during firing of the preform, as a result of which a cordierite material is formed.

The formation of the cordierite material preferably binds the particles of the base material together.

In order to form the pore structure, it may be favorable if the mixture comprises a pore-forming material. The pore-forming material preferably comprises one or more of the following materials or is formed therefrom: potato starch, graphite, coconut flour, acrylic glass, acrylate.

As an alternative to an additional pore-forming material, it can be provided that gases released during the firing of the base material or one or more precursors of the binding material escape from the mixture and the pore structure is thus formed.

The additional pore-forming material preferably combusts to form gaseous components, which escape from the material to form the pore structure.

It may be advantageous if a proportion of the pore-forming material is approximately 5 wt. % or more, in particular approximately 10 wt. % or more, based on a total mass of the mixture.

In particular, the proportion of the pore-forming material is approximately 20 wt. % or less, in particular approximately 15 wt. % or less, based on the total mass of the mixture.

Preferably, the mixture comprises one or more precursors which react to form a binding material. The binding material binds particles of the base material together. In particular, the binding material comprises one or more of the following materials or is formed therefrom:
one or more transition metal oxides, in particular titanium dioxide;
one or more aluminum oxides;
one or more alkaline earth metal oxides, in particular magnesium oxide; and
one or more silicates.

Magnesium silicates are also suitable as silicates.

The following composition is particularly preferred for the precursors: titanium dioxide, a plurality of aluminum oxides, one or more kaolins, magnesium oxide, kaolin chamotte, aluminum hydroxide, one or more silicates.

In embodiments in which titanium dioxide is used, a proportion of the titanium dioxide is preferably approximately 1 wt. % or more and/or approximately 5 wt. % or less, based on the total mass of the binding material or based on the total mass of the mixture.

A composition of the precursors is preferably selected in such a way that cordierite forms as a component of the binding material.

The present invention also relates to a method for producing a composite body, in particular a composite body according to the invention.

In this regard, the object of the invention is to provide a method for producing a composite body, by means of which a composite body can be produced which has high temperature stability and high mechanical stability.

According to the invention, this object is achieved by a method according to independent claim 15.

According to the method, a shaped body is preferably provided, in particular a shaped body according to the invention.

A coating material mixture is preferably applied to the shaped body and/or onto the shaped body. The coating material mixture preferably comprises a coating material and a liquid.

The shaped body and the coating material mixture applied thereto and/or thereon are preferably fired, so that the coating material forms a coating at the shaped body and/or on the shaped body, with approximately 5 vol. % of the coating material or more, based on a total volume of the pore structure, being absorbed into pores of a pore structure in a material of the shaped body.

The method according to the invention for producing a composite body preferably has one or more features and/or one or more advantages of the method according to the invention for producing a shaped body, the shaped body according to the invention and/or the composite body according to the invention.

For example, the liquid of the coating material mixture is water.

It may be advantageous if the coating material is in powder form and/or is formed by calcination.

The shaped body and/or the composite body preferably also have the following features and/or advantages:
increased absorption of the coating material in the pore structure of the shaped body reduces a pressure loss and/or increases an activity with the same loading; and/or
approximately 20% to approximately 30% reduced weight of the shaped body due to the porosity; and/or
optimized adaptation of the material of the shaped body to the coating material; and/or
due to the improved adhesion of the coating material to the shaped body, the connection between the coating material and the shaped body is secured against mechanical abrasion and/or crumbling due to vibrations; and/or
cracking in the coating material is minimized; and/or
in comparison to a fully extruded catalyst material, mechanical stability increased by a factor of 5 can be formed; and/or
the composite body is less brittle in comparison to a fully extruded catalyst material; and/or
in comparison to a fully extruded catalyst material, the composite body has a coefficient of thermal expansion that is lower by a factor of 3; and/or
in comparison to a fully extruded catalyst material, conversion of sulfur dioxide to sulfur trioxide is optimized; and/or
a coefficient of thermal expansion of the shaped body at 800° C. is approximately 3×10⁻⁶/K or more and/or approximately 4×10⁻⁶/K or less.

Further preferred features and/or advantages of the invention are the subject matter of the following description and embodiments illustrated in the drawings.

In the drawings:

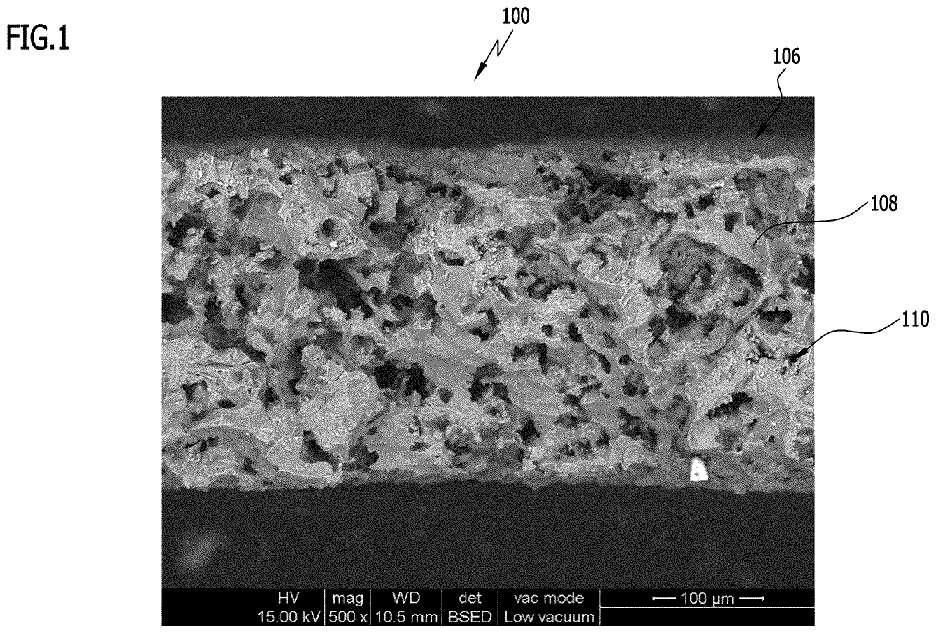

FIG. 1 is a first scanning electron microscope image of a section through a wall of an embodiment of a shaped body in an uncoated state;

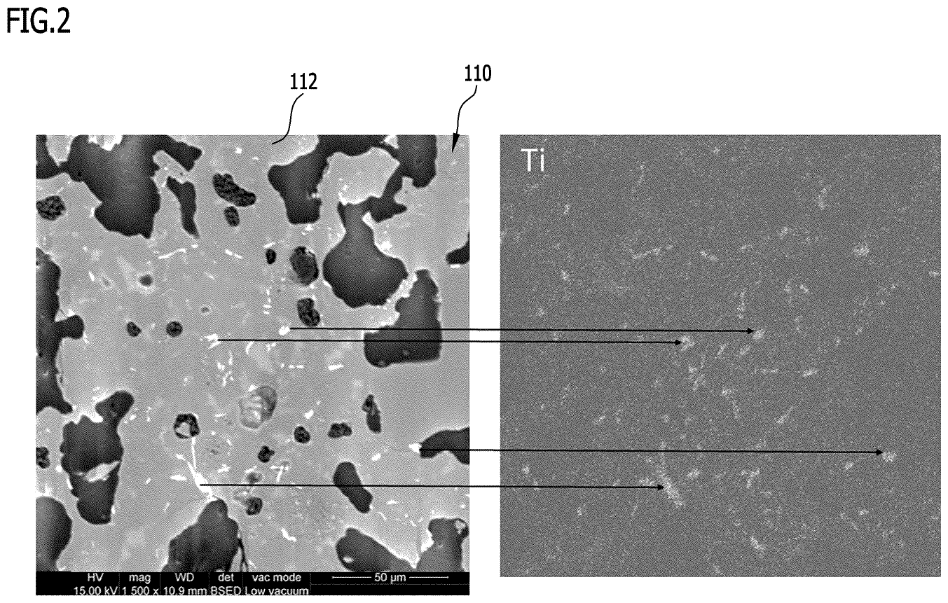

FIG. 2 shows a comparison of a scanning electron microscope image of a section through a wall of a shaped body and an EDX mapping of the same region;

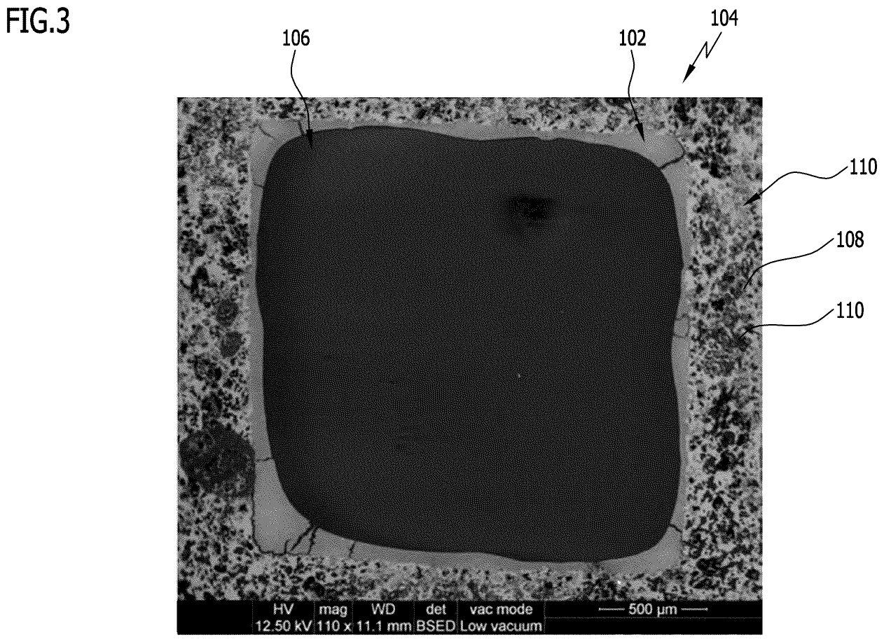

FIG. 3 is a scanning electron microscope image of an embodiment of a composite body, where a shaped body has been coated with a coating material, in a section perpendicular to a main extension direction of a channel of the shaped body; and

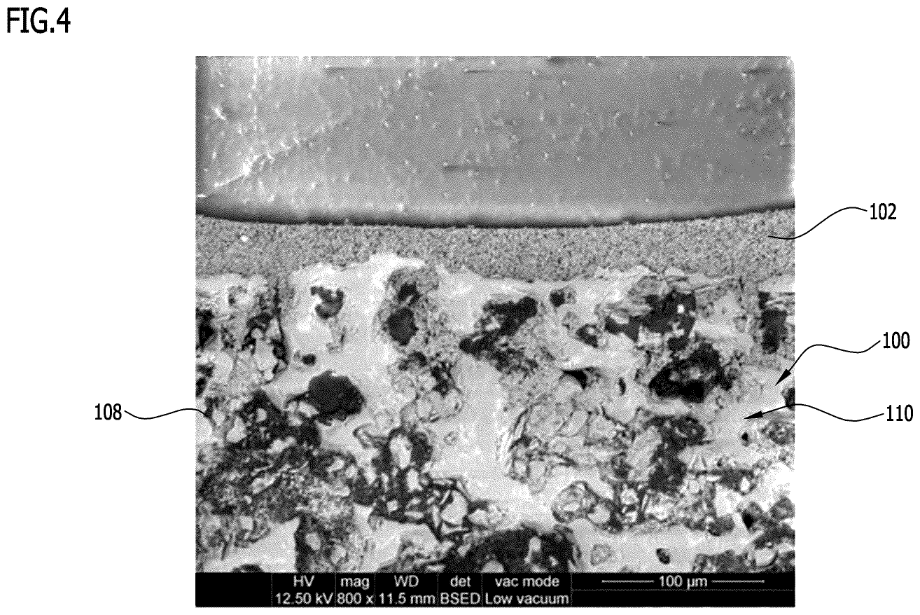

FIG. 4 is a scanning electron microscope image of the composite body from FIG. 3 magnified 800 times.

The same or functionally equivalent elements are provided with the same reference signs in all figures.

An embodiment shown in FIG. 1 of a shaped body, designated as a whole by 100, preferably forms a carrier body for a coating material 102 (cf. FIGS. 3 and 4). The shaped body 100 and the coating material 102 together form a composite body 104 in a coated state of the shaped body 100.

The shaped body 100 can have dimensions of up to 450 mm in all spatial directions.

The shaped body 100 preferably has cavities which are arranged regularly by shaping a material of the shaped body 100 and through which a channel structure 106 of the shaped body 100 is formed.

The channel structure 106 is preferably a macroscopic channel structure.

The shaped body 100 preferably forms a honeycomb body which has channels with an at least approximately square cross section.

FIG. 1 shows a scanning electron microscope (SEM) image through a wall 108 of the channel structure 106 of the shaped body 100. The SEM image was captured with a backscattered electron detector at an acceleration voltage of 15.00 kV and shows the wall 108 of the channel structure 106 of the shaped body 100 magnified 500 times.

A wall thickness of the wall 108 of the channel structure 106 of the shaped body 100 is preferably approximately 150 μm or more, in particular approximately 200 μm or more. In particular, the wall thickness of the wall 108 is approximately 500 μm or less, for example approximately 300 μm or less.

A wall thickness of 290 μm has proven to be a particularly preferred wall thickness.

The wall thickness is preferably an average wall thickness.

It may be favorable if the shaped body 100 comprises 100 or 150 cells per square inch.

In addition to the channel structure 106 formed by shaping the material of the shaped body, the shaped body 100 has a pore structure 110 which is formed in the material of the shaped body 100.

The pore structure 110 is preferably a microscopic pore structure.

The pores of the pore structure 110 are shown darker than the material of the shaped body 100 in all of the SEM images.

A porosity of the pore structure 110 is preferably approximately 35% or more, in particular approximately 43% or more.

In particular, the porosity of the pore structure 110 is approximately 54% or less, in particular approximately 46% or less.

“Porosity” is preferably understood to mean a ratio of a cavity volume and a total volume of the pore structure 110. Cavities formed by shaping the material to form the channel structure 106 are excluded from the overall volume of the pore structure 110.

An average pore diameter of the pores of the pore structure 110 of the shaped body 100 is preferably approximately 10 μm or more, in particular approximately 12 μm or more.

In particular, the average pore diameter of the pore structure 110 of the shaped body 100 is approximately 20 μm or less, for example approximately 16 μm or less.

The porosity of the pore structure 110 is preferably an open porosity. The coating material 102 can thus penetrate into pores of the pore structure 110 of the shaped body 100 during the production of the composite body 104.

A mass concentration and/or density of the shaped body 100 is preferably approximately 300 g/l or more and/or approximately 450 g/l or less. For example, the mass concentration and/or bulk density plus cavities of the shaped body 100 formed by the channel structure is approximately 350 g/l.

As can be seen in particular in FIG. 1, outer surfaces of the walls 108 of the channel structure 106 of the shaped body 100 have a rough surface.

For example, a so-called extrusion skin of the shaped body 100 is designed to be rough and/or spatially structured.

The material of the shaped body 100 preferably comprises base material which comprises a cordierite material and/or a mullite material or is formed therefrom.

The base material of the material of the shaped body 100 is preferably in powder form and/or particulate.

It may be advantageous if particles of the base material are connected to one another, in particular integrally, by means of a binding material 112 and/or are bonded to one another by means of the binding material 112.

The particles of the base material are preferably surrounded by the binding material 112 in the shaped body 100 (cf. FIG. 4).

In order to produce the shaped body 100, a mixture is preferably provided or produced which is shaped into a preform and then fired in a rapid firing process.

The mixture preferably comprises the base material and precursors of the binding material 112.

It may be advantageous if titanium dioxide, one or more aluminum oxides, one or more magnesium oxides, one or more silicates and aluminum hydroxide are used as precursors of the binding material 112.

For example, one or more of the following materials are used as precursors for the binding material: titanium dioxide, a plurality of aluminum oxides, one or more kaolins, magnesium oxide, kaolin chamotte, aluminum hydroxide, one or more silicates.

Magnesium silicates, for example a product of the Finntalc series from Mondo Minerals B.V., 1041 AR Amsterdam, Netherlands, are also suitable as silicates.

As aluminum oxides, the following are particularly well suited, for example:
the product NABALOX® NO 715-10 from Nabaltec AG, 92409 Schwandorf;
one of the products in the aluminum oxide CT series from GÜPO GmbH, 77694 Kehl.

It may be advantageous if a proportion of the one or more precursors of the binding material 112 is approximately 10 wt. % or more and/or approximately 35 wt. % or less, based on a total mass of the mixture.

In embodiments in which titanium dioxide is used, a proportion of the titanium dioxide is preferably approximately 1 wt. % or more and/or approximately 5 wt. % or less, based on the total mass of the binding material 112 or based on the total mass of the mixture.

It may be advantageous if the mixture contains a pore-forming material in addition to the base material and the precursors of the binding material.

The pore-forming material is used in particular to form pores in the material of the shaped body 100.

The pore-forming material is added, for example, before and/or during the formation of the preform.

It may be favorable if the pore-forming material comprises one or more of the following materials or is formed therefrom: potato starch, graphite, coconut flour, acrylic glass, acrylate.

A proportion of the pore-forming material is preferably approximately 5 wt. % or more and/or approximately 20 wt. % or less, based on the total mass of the mixture.

As already described, the base material is preferably in the form of a powder and/or particulate.

A grain size distribution (particle size distribution) of the particles of the cordierite material and/or the mullite material is preferably as follows:
d₁₀ approximately 1 μm or more and/or approximately 3 μm or less, for example 2 μm; and/or
d₅₀ approximately 10 μm or more and/or approximately 28 μm or less, for example approximately 18 μm; and/or
d₉₀ approximately 30 μm or more and/or approximately 40 μm or less, for example 35 μm.

A d₁₀ value is understood to mean the particle size below which 10% of the particles of the relevant substance fall, while 90% of the particles of the relevant substance are larger than the d₁₀ value.

A d₅₀ value is understood to mean the particle size below which 50% of the particles of the relevant substance fall, while 50% of the particles of the relevant substance are larger than the d₅₀ value.

A d₉₀ value is understood to mean the particle size below which 90% of the particles of the relevant substance fall, while 10% of the particles of the relevant substance are larger than the d₉₀ value.

Comparatively coarse-grained cordierite material and/or mullite material is preferably used as the base material. Overall, an average grain size of the particles of the cordierite material and/or mullite material used in the base material is approximately 100 μm or less, for example.

In order to produce the base material, the cordierite material and/or the mullite material are preferably fired, for example calcined. After a firing process, the cordierite material and/or the mullite material are preferably ground up and sieved, for example.

According to a preferred embodiment, cordierite material and no mullite material is used in or as the base material.

Alternatively, a proportion of approximately 10 wt. % or less of mullite material, based on a total mass of the base material, can be used. A proportion of the cordierite material is then in particular approximately 90 wt. %, based on the total mass of the base material.

It has already been described that a preform is preferably first formed from the mixture used to produce the shaped body 100. This is preferably carried out by pressing and/or extrusion. This produces in particular the channel structure 106 of the shaped body 100.

After shaping, the preform is preferably dried, for example by means of microwave heating in a continuous furnace.

The preform is then preferably fired, as a result of which the shaped body 100 is formed. The firing is preferably carried out in a rapid firing continuous furnace. A pushing speed ranges from approximately 3 cm/min to approximately 10 cm/min, for example.

The shaped body 100 is preferably produced in a rapid firing process in which a preform is fired with a temperature gradient of more than 2300° C., in particular more than 2200 K/m and/or more than 2200 K/h, for example in the range between approximately 120° C. and approximately 2000° C.

The shaped body 100 is preferably produced when the preform is fired at temperatures of at most approximately 1400° C. In this way, it is possible to connect the particles of the base material to one another while maintaining the particle property.

The preform is preferably fired at a temperature of approximately 1300° C., as a result of which the shaped body 100 is formed.

It may be favorable if the preform is fired in a firing cycle lasting at least approximately 300 minutes and/or at most approximately 480 minutes, for example approximately 430 minutes to approximately 450 minutes.

The duration of the firing cycle is understood to mean the time between the start of the firing process of the preform and the end of the firing process, in particular when the shaped body 100 formed during the firing process is removed from a furnace. In particular, this is understood to mean the length of time between the start of the firing process and the cooling of the fired shaped body 100.

When the preform is fired, the one or more non-pre-fired precursors of the binding material 112 preferably react, for example to form a cordierite material and other substances, while particles of the base material are only superficially melted and/or react with the components of the binding material only on their surface 112.

Preferably, approximately 70 vol. % or more of the particles of the base material remain chemically and/or physically unchanged, particularly in an interior of the particles.

As already mentioned, the resulting shaped body 100 preferably forms a carrier body for the coating material 102 (cf. FIGS. 3 and 4).

In order to produce the composite body 104, the coating material 102 is applied to and/or on the shaped body 100, for example by means of dip coating.

For adhesion of the coating material 102 and/or a connection of the material of the shaped body 100 and the coating material 102, it can be advantageous if the coating material 102 has one or more substances and/or components and/or materials which are also contained in the same chemical composition and/or in chemically identical form in the material of the shaped body 100.

According to a preferred embodiment, titanium dioxide is used both as a precursor of the binding material 112 and as a component of the coating material 102.

The presence of the titanium dioxide in the shaped body can be seen from the comparison shown in FIG. 2 of an SEM image and an EDX (energy dispersive X-ray spectroscopy) mapping of the same region.

FIG. 2 shows an SEM image on the left, which was captured with 1500× magnification and an acceleration voltage of 15.00 kV. A backscattered electron detector was used.

The SEM image shows that dark particles are absorbed in a lighter material. These dark particles are the particles of the base material, which also continue to have particle properties in the fired shaped body 100. The lighter material surrounding the particles is the binding material 112.

Inclusions shown in white can be seen in the lighter material. These inclusions comprise titanium, because a signal at energy characteristic of titanium is detected in the EDX (energy dispersive X-ray spectroscopy) mapping of the same region shown on the right. Since titanium was contained exclusively in titanium dioxide in the starting materials, it can be assumed that the white inclusions are made of titanium dioxide.

The correlation is indicated by arrows.

The material has an overall porosity, with cavities being shown comparatively dark.

The use of titanium dioxide both in the material of the shaped body 100 and in the coating material 102 improves the interaction thereof. This can be seen from FIGS. 3 and 4.

The coating material 102 shown in FIGS. 3 and 4 preferably comprises titanium dioxide and/or vanadium oxide, in particular vanadium (V) oxide, and/or tungsten oxide, in particular tungsten (VI) oxide.

FIGS. 3 and 4 are SEM images of a section through the shaped body 100 coated with the coating material 102. The acceleration voltage for the images is 12.50 kV in each case.

The image shown in FIG. 3 was taken with 110× magnification and shows a honeycomb of the shaped body 100. The coating material 102 is applied to an inner side facing the cavity.

FIG. 4 shows the transition between the coating material 102 and the wall 108 of the shaped body 100 at 800× magnification.

A backscattered electron detector was used both for the image in FIG. 3 and for the image shown in FIG. 4.

FIG. 4 clearly shows that approximately 5 vol. % or more, in particular approximately 10 vol. % of the coating material 102 or more, based on a total volume of the pore structure 110, is absorbed into pores of the pore structure 110 of the shaped body 100. The material contrast with which the coating material 102 is shown can also be seen within the pores.

According to a preferred composition, the coating material 102 comprises the following materials or is formed therefrom: titanium dioxide, vanadium (V) oxide and tungsten (VI) oxide.

A proportion of the titanium dioxide in the coating material 102 is preferably approximately 80 wt. % or more, based on a total mass of the coating material 102.

For example, a mixture containing approximately 88 wt. % to approximately 93 wt. % titanium dioxide, approximately 0.5 wt. % to approximately 3 wt. % vanadium (V) oxide, for example approximately 2 wt. % vanadium (V) oxide, and approximately 5 wt. % to approximately 10 wt. % tungsten (VI) oxide is used to form the coating material 102.

It may be advantageous if one or more additives are admixed to the resulting mixture. Monoethanolamine and/or a colloidal silicon dioxide dispersion, for example, are suitable as one or more additives.

A proportion of the silicon dioxide dispersion is preferably approximately 2 wt. % or more and/or approximately 5 wt. % or less, based on a total mass of the mixture. A proportion of the silicon dioxide in the silicon dioxide dispersion is preferably 30 wt.%, based on a total mass of the silicon dioxide dispersion.

The mixture is preferably dried in a furnace and then calcined at approximately 400° C. to approximately 600° C.

In order to apply the coating material 102 to the shaped body 100, the coating material 102 is preferably dissolved and/or dispersed in a liquid. A quantity of the liquid preferably corresponds to a pore volume of the shaped body 100.

After application, the composite body 104 is preferably produced by firing.

The shaped body 100 and/or the composite body 104 are particularly suitable for use in exhaust gas aftertreatment, for example as catalytic converters and/or as diesel particle filters.

1. Shaped body (100), in particular as a carrier body for a coating material (102), the shaped body (100) comprising the following:
a channel structure (106) which is formed by shaping a material of the shaped body (100); and
a pore structure (110) in the material of the shaped body (100), wherein the material of the shaped body (100) comprises a particulate base material or is formed therefrom at least in part, wherein the base material comprises a cordierite material and/or a mullite material, wherein particles of the base material are connected to one another directly and/or indirectly, wherein approximately 5 vol. % of a coating material (102) or more, based on a total volume of the pore structure (110), can be or is absorbed into pores of the pore structure (110).

2. Shaped body (100) according to claim 1, characterized in that the material of the shaped body (100) comprises a binding material (112) by means of which particles of the base material are connected to one another, in particular integrally, the binding material (112) in particular comprising one or more of the following materials or being formed therefrom:
one or more transition metal oxides, in particular titanium dioxide;
one or more aluminum oxides;
one or more alkaline earth metal oxides, in particular magnesium oxide; and
one or more silicates.

3. Shaped body (100) according to either claim 1 or claim 2, characterized in that a porosity of the pore structure (110) is approximately 35% to approximately 54%, in particular approximately 43% to approximately 46%, and/or in that an average pore diameter of the pores of the pore structure (110) is approximately 7 μm to approximately 20 μm, more preferably approximately 10 μm to approximately 16 μm.

4. Shaped body (100) according to any of claims 1 to 3, characterized in that the shaped body (100) has a mass concentration of approximately 450 g/l or less, in particular approximately 360 g/l or less.

5. Composite body (104) comprising a shaped body (100) according to any of claims 1 to 4 and a coating material (102).

6. Composite body (104) according to claim 5, characterized in that the coating material (102) extends into pores of the pore structure (110) of the shaped body (100) in a coated state of the shaped body (100) and/or in that the coating material (102) is chemically and/or physically connected to the material of the shaped body (100).

7. Composite body (104) according to either claim 5 or claim 6, characterized in that one or more components and/or substances and/or materials are contained in the same chemical composition and/or in chemically identical form both in the material of the shaped body (100) and in the coating material (102).

8. Composite body (104) according to any of claims 5 to 7, characterized in that the coating material (102) comprises one or more of the following materials or is formed therefrom: titanium dioxide, vanadium oxide, in particular vanadium (V) oxide, tungsten oxide, in particular tungsten (VI) oxide.

9. Method for producing a shaped body (100), in particular a shaped body (100) according to any of claims 1 to 4, wherein the method comprises the following:
providing a mixture comprising a particulate base material which is pre-fired and/or ground up and which comprises a cordierite material and/or a mullite material or is formed therefrom;
producing a preform by shaping the mixture, wherein in particular a channel structure (106) is formed; and
firing the preform, so that particles of the base material are connected to one another directly and/or indirectly, wherein a shaped body (100) is formed, wherein the shaped body (100) has a pore structure (110), wherein approximately 5 vol. % of a coating material (102) or more, based on a total volume of the pore structure (110), can be absorbed into pores of the pore structure (110).

10. Method according to claim 9, characterized in that the mixture comprises one or more precursors of a binding material (112) and in that the particles of the base material are taken up by the binding material (112) by chemical and/or physical reaction of the one or more precursors to the binding material (112) and/or are connected to one another by the binding material (112).

11. Method according to either claim 9 or claim 10, characterized in that an average grain size of the particles of the base material is greater by a factor of 2 or more than a grain size of one or more precursors which, by firing, form a binding material (112) of the material of the shaped body (100).

12. Method according to any of claims 9 to 11, characterized in that the mixture comprises a pore-forming material, in particular the pore-forming material comprising one or more of the following materials or being formed therefrom: potato starch, graphite, coconut flour, acrylic glass, acrylate.

13. Method according to claim 12, characterized in that the proportion of the pore-forming material is approximately 5 wt. % or more, in particular approximately 10 wt. % or more, based on a total mass of the mixture.

14. Method according to any of claims 9 to 13, characterized in that the mixture comprises one or more precursors which react to form a binding material (112) by means of which particles of the base material are connected to one another, the binding material (112) in particular comprising one or more of the following materials or being formed therefrom:
one or more transition metal oxides, in particular titanium dioxide;
one or more aluminum oxides;
one or more alkaline earth metal oxides, in particular magnesium oxide; and
one or more silicates.

15. Method for producing a composite body (104), in particular a composite body (104) according to any of claims 5 to 8, wherein the method comprises the following:
providing a shaped body (100), in particular a shaped body (100) according to any of claims 1 to 4;
applying a coating material mixture to the shaped body (100), wherein the coating material mixture comprises a coating material (102) and a liquid or is formed therefrom; and
firing the shaped body (100) and the coating material mixture applied thereto, so that the coating material (102) forms a coating on the shaped body (100), wherein approximately 5 vol. % of the coating material (102) or more, based on a total volume of the pore structure (110), is absorbed into pores of a pore structure (110) in a material of the shaped body (100).
